(19) United States
(12) Patent Application Publication
(10) Pub. No.: US 2020/0234319 A1
(43) Pub. Date: Jul. 23, 2020

(54) SYSTEM AND METHOD FOR CALCULATING, MEASURING AND AFFECTING PARTICIPANT ENGAGEMENT

(71) Applicant: Chidi Paul Okechukwu, Beaumont Hills (AU)

(72) Inventor: Chidi Paul Okechukwu, Beaumont Hills (AU)

(21) Appl. No.: 16/842,765

(22) Filed: Apr. 8, 2020

(51) Int. Cl. G06Q 30/02; G06F 16/22; G06F 16/28

(52) U.S. Cl. CPC G06Q 30/0203; G06F 16/284; G06F 16/22

(57) ABSTRACT

Present disclosure relates to a technique of generating participant engagement scores. The technique includes monitoring a plurality of activities of at least one participant of an interaction platform. The technique further includes obtaining participation, persuasion and praise information associated with the at least one participant. The technique further includes determining plurality of score values based on each of the plurality of participation information, persuasion information, and praise information, wherein the score values are determined based on plurality of scores stored in a database. The technique furthermore includes evaluating the plurality of score values to determine a final score and determining an engagement level of the at least one participant based on the determined score.

### TECHNICAL FIELD

The present disclosure generally relates to the field of calculating and measuring the engagement levels of participants. More precisely, but not exclusively, the present disclosure describes a system and method for determining participant engagement in real time, based on three key factors: Participation, Persuasion and Praise.

### BACKGROUND

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Conventional methods for measuring participant engagement usually involve conducting participant sentiment surveys. There can be large delays between drafting the survey, distributing the survey, gathering survey responses, analyzing the collected data, and presenting the results. Given the amount of effort required, participant sentiment surveys are often only conducted annually. Another impediment is the disconnect in time between the events, issues and situations that the respondents are required to recall in their answers and the actual time when they occurred. There are also the inherent biases to survey questions, including social desirability bias, hypothetical bias and the Hawthorne effect, amongst others. In summary, survey measurements of preferences, judgements and beliefs are notably biased and subjective.

Further, even after gathering participant sentiment survey results, a critical component of participant engagement, participant performance, may be missing. Typically, the process of optimizing participant engagement has been manual. Even if an aspect of the effort to optimize participant engagement is automated, typical systems used to support these efforts do not contemplate the overall process and thus lack the seamless integration of functionality and data that is needed. For instance, a system may collect survey data but lack the ability to effectively analyze data and leverage the data by providing a means to devise and implement corrective action plans.

In light of the above-mentioned limitations, among other things, in order to measure participant engagement accurately, companies may desire a system that seamlessly ties participant engagement to activities undertaken in the ordinary course of business.

None of the prior art methods have been found to be completely suitable to meet these needs, besides also being cumbersome. The present invention provides such a method and the overall combination of these features is nowhere disclosed in the prior art cited above which appears to be representative of the general art in this area although it is not intended to be an all-inclusive listing of pertinent prior art patents.

### SUMMARY

The present disclosure overcomes one or more shortcomings of the prior art and provides additional advantages discussed throughout the present disclosure. Additional features and advantages are realized through the techniques of the present disclosure. Other embodiments and aspects of the disclosure are described in detail herein and are considered a part of the claimed disclosure.

In one non-limiting embodiment of the present disclosure, a method for generating participant engagement scores is provided. The method comprises a step of monitoring a plurality of activities of at least one participant of an interaction platform. The method further comprises a step of obtaining participation information, persuasion information and praise information associated with the at least one participant. The method further comprises a step of determining plurality of score values based on each of the participation information, persuasion information, and praise information, wherein the score values are determined based on plurality of scores stored in a database. Further, at next step the method describes computing the plurality of score values to determine a score. Lastly, the method describes determining an engagement level of the at least one participant based on the determined score.

In another non-limiting embodiment of the present disclosure, the method describes that the participation information associated with the at least one participant is obtained utilizing at least one of the interaction platform and an external source.

In yet another non-limiting embodiment of the present disclosure, the method describes that the persuasion information associated with the at least one participant is obtained utilizing at least one of the interaction platform and an external source.

In yet another non-limiting embodiment of the present disclosure, the method describes that the praise information associated with the at least one participant is obtained utilizing at least one of the interaction platform and an external source.

In yet another non-limiting embodiment of the present disclosure, the step of determining the engagement level of the at least one participant based on the determined score comprise: comparing the determined score with one or more thresholds.

In yet another non-limiting embodiment of the present disclosure, the participation information, the persuasion information, and the praise information associated with the at least one participant are obtained based on the plurality of activities.

In yet another non-limiting embodiment of the present disclosure, a system for generating participant engagement scores is provided. The system comprises at least one processor, an activity detecting unit, and a database coupled to the at least one processor.

The at least one processing unit is configured to monitor a plurality of activities of at least one participant of an interaction platform, obtain participation information associated with the at least one participant, obtain persuasion information associated with the at least one participant, obtain praise information associated with the at least one participant, determine plurality of score values based on each of the participation information, persuasion information, and praise information, wherein the score values are determined based on plurality of scores stored in a database, evaluating the plurality of score values to determine a final score and determine an engagement level of the at least one participant based on the determined score.

In another non-limiting embodiment of the present disclosure, the participation information associated with the at least one participant is obtained utilizing at least one of the interaction platform and an external source.

In another non-limiting embodiment of the present disclosure, the persuasion information associated with the at least one participant is obtained utilizing at least one of the interaction platform and an external source.

In yet another non-limiting embodiment of the present disclosure, the praise information associated with the at least one participant is obtained utilizing at least one of the interaction platform and an external source.

In yet another non-limiting embodiment of the present disclosure, the participation information, the persuasion information, and the praise information associated with the at least one participant are obtained based on the plurality of activities.

In another non-limiting embodiment of the present disclosure, the at least one processor is configured to determine the engagement level of the at least one participant based on the determined score by: comparing the determined score with one or more thresholds.

### BRIEF DESCRIPTION OF THE ACCOMPANYING DRAWINGS

The features, nature, and advantages of the present disclosure will become more apparent from the detailed description set forth below when taken in conjunction with the drawings in which like reference characters identify correspondingly throughout. Some embodiments of system and/or methods in accordance with embodiments of the present subject matter are now described, by way of example only, and with reference to the accompanying figures, in which:

FIG. 1 shows a block diagram illustrating a system for generating participant engagement scores in accordance with an embodiment of the present disclosure.

FIG. 2 shows a full view of the Engagement Pillars score calculation mechanism in accordance with an embodiment of the present disclosure.

FIG. 3 shows Engagement Framework in accordance with an embodiment of the present disclosure.

FIG. 4 shows a flowchart of an exemplary method for generating participant engagement scores in accordance with an embodiment of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration”. Any embodiment or implementation of the present subject-matter described herein as “exemplary” is not necessarily to be construed as preferred or advantageous over other embodiments.

While the disclosure is susceptible to various modifications and alternative forms, specific embodiments thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, “include(s)”, or any other variations thereof, are intended to cover a non-exclusive inclusion, such that a setup, system or method that comprises a list of components or steps does not include only those components or steps but may include other components or steps not expressly listed or inherent to such setup or system or method. In other words, one or more elements in a system or apparatus proceeded by “comprises . . . a” does not, without more constraints, preclude the existence of other elements or additional elements in the system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The present disclosure will be described herein below with reference to the accompanying drawings. In the following description, well known functions or constructions are not described in detail since they would obscure the description with unnecessary detail.

The present disclosure relates to a system that generates participant engagement scores and thereafter recommends action steps for participants to increase their current engagement level or for an intervention to be undertaken by a responsible party.

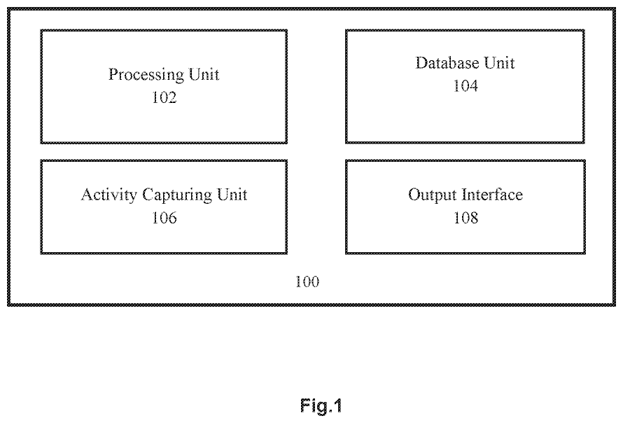

Referring to FIG. 1, an exemplary system 100 is disclosed for generating engagement score of at least one participant. The system 100 may include various elements such as at least one processing unit 102, a database unit 104, at least one activity capturing unit 106 and an output interface 108. The at least one processing unit 102, a database unit 104, at least one activity capturing unit 106, and an output interface 108 may communicate with each other over wired or wireless link. The system 100 may monitor plurality of activities of at least one participant via the activity detecting unit 106 and provide one or more outputs such as generated scores via the output interface 108.

According to a non-limiting exemplary embodiment of the present disclosure, the database unit 104 may store following participation information. The information may comprise one or more activities information that may be performed by at least one participant, The one or more activities may comprise doing something, attending, partaking, and contributing, checking in, nominating, taking part in challenges and events, gameplay, referring, contributing to activities online or offline via comments, liking and recognizing associated with the interaction platform.

The database unit 104 may also store Persuasion information which is related to key deliverables assigned to the participant. The persuasion information may cover the primary responsibilities of the participant's role, position or relationship that are measurable (like purchasing, selling, building, developing, solving, supporting, helping, fixing, growing, etc). Elementary inputs may include streams of data from Key Performance Indicators (KPI), Key Result Areas (KRA) and assigned Challenges.

The database 104 may also store Praise information which relates to the recognition received by at least one participant. The at least one participant may receive praise for effort, tenure, milestones, or other achievements. Praise may come from subordinates, peers, managers and other parties. Praise may be formal or informal and may include tangible and intangible incentives and awards.

In an exemplary embodiment, a non-exhaustive list of internal modules that contribute data to the system for generating the engagement score may comprise following, but not limited thereto: Peer Commendation, Attendance, Nomination, Milestone, Survey, KPI, Challenge, Event, Feedback, Referral, Display Feeds, Documents, Gifting, Catalog, Knowledge Base, Onboarding, Claims, Contests, Cashback, Affiliates, Offers, Participant of the Month (e.g. Employee of the Month, Customer of the Month, Fan of the Month, Partner of the Month, Member of the Month, Teacher of the Month, Student of the Month, etc.). More modules may be included as necessary.

The information stored in the database unit 104 may be used by the system 100 to determine the engagement score of the at least one participant and may provide recommendations to increase the engagement with the interaction platform, if required.

The plurality of activities may be stored in the database unit 104 in association with at least one of the persuasion information. The database unit 104 may further store one or more of the following information, but not limited to: one or more scores assigned to the activities in association with the persuasion information. Further, the database unit 104 may also store one or more scores for various persuasion information.

The database unit 104 may also store one or more score values associated with the praise information. Different type of praise information may be assigned different scores. The system 100 may generate the participant engagement scores utilizing the one or more scores stored in the database unit 104.

Referring again to FIG. 1, the at least one processing unit 102 may comprise at least one processor and a memory. The at least one processing unit 102 of the system 100 may be trained for various scenarios, as described above, to generate the engagement score of the at least one participant in real time based on participation information, persuasion information, and praise information associated with the at least one participant. The database unit 104 of the system 100 may store all the training data for generate the engagement score of the at least one participant in real time.

In an embodiment, the activity detection unit 106 may detect plurality of activities of at least one participant. The plurality of activities may represent any activity which is being performed by the at least one participant over the participant platform. In an exemplary embodiment, the activity detection unit 106 may comprise at least one processor.

The at least one processing unit 102 may determine participation information based on identified activities. The at least one processing unit 102 may further receive persuasion information via the input unit 110. The at least one processing unit 102 may identify the persuasion information associated with the at least one participant. Further, the at least one processing unit 106 may also identify the praise information associated with the at least one participant.

The at least one processing unit 102 may determine a score value for each one of the participation information, persuasion information, and praise information. The at least one processing unit 102 may determine the score values based on plurality of scores stored in the database unit. Further, the processing unit 102 evaluates the plurality of score values to determine a final score. Based on the final score, the processing unit 102 determines an engagement level of the at least one participant.

The at least one processing unit 102 may obtain the praise information associated with the at least one participant is from at least one of the interaction platform and an external source. Further, the persuasion information associated with the at least one participant may be obtained based on at least one of the interaction platform and an external source.

In the same embodiment, the processing unit 102 may compare the determined final score with one or more thresholds stored in the database unit 104. The one or more thresholds represents different engagement levels. For example, the engagement levels may be low, medium and high engagement level based on a first and second threshold. The engagement score below the first threshold represents low engagement, the score in between the first and second threshold represents medium engagement and the score higher than second threshold represents high engagement.

The system 100 may provide the recommendations based on the determined engagement level to increase the engagement, as required. The system 100 seamlessly ties participant engagement to activities undertaken in the ordinary course of business. These activities may be categorized, in the present invention, into three primary activity streams (modes) that feed data into three confluences (pillars). These confluences form a nexus (composite measure) at their points of intersection. The three confluences, termed Pillars, are Participation, Persuasion and Praise. The pillars generate a composite measure [engagement score] at their intersection, or nexus.

In an exemplary embodiment, Participation may encompass actions and activities of the participant indicating involvement, attendance, presence, taking part, acting and reacting.

In an exemplary embodiment, Persuasion may involve making a participant accountable for their actions, for their work, for meeting desired expectations. Persuasion also includes making the participant aware of their responsibilities, as well as tracking, calculating and measuring their performance. Persuasion may relate to key deliverables assigned to the participant. They cover the primary responsibilities of the participant's role, position or relationship that are measurable (like purchasing, selling, building, developing, solving, supporting, helping, fixing, growing, etc). Elementary inputs may include streams of data from Key Performance Indicators (KPI), Key Result Areas (KRA) and assigned Challenges.

In an exemplary embodiment, Praise may be any recognition that the participant may receive for their actions, activities, milestones, achievements and performance. Praise can be formal or informal, offered by peers, managers, or other parties. Praise may relate to the recognition received by participants. Participants may receive praise for effort, tenure, milestones, or other achievements. Praise may come from subordinates, peers, managers and other parties. Praise may be formal or informal and may include tangible and intangible incentives and awards.

In an exemplary embodiment, the system may provide a link between the engagement framework and the organizational context. The organizational context, or Org Context, may capture the objectives, structure and socio-cultural characteristics of the organization. Information pertinent to the Context may include operational units and locations, organizational values and behaviors, business drivers, key result areas, and external parties applicable to the engagement program. This linkage may ensure that the streams of data flowing into the Engagement Pillars are relevant to the organization and its objectives. The system 100 may utilize the context information while determining the scores. Further, the system 100 may ensure that the engagement score is accurate in every sense, tailored to meet the needs of the organization, leading to a high-value experience for all parties.

In an exemplary embodiment, the system 100 creates multiple subprograms aligned with one or multiple Context elements, and algorithms that generate Engagement Scores at program and subprogram levels. The system 100 may analyze various activities and information based on a variety of factors, such as the organizational context, predefined rules, historical data, etc.

In an exemplary embodiment, a user may use the system to address results, generate an action plan, and track progress toward expected goals. The system allows organizations to identify the levels of engagement of their participant base e.g. individually, in teams, groups, sections, branches, units, schools, classes, locations, organization-wide, etc.

In an exemplary embodiment, the system 100 may utilize statistical, analytical and intelligence methods to generate the engagement score such as: a) Artificial Intelligence, b) Machine Learning and, c) Benchmarking. The Artificial Intelligence (AI) component may assists in making sense of the data and providing actionable feedback to participants and decision-makers. The Machine Learning component may entail a continuous analysis of the data to understand participant's metrics and influences. The Benchmarking component may compare reference data from other programs to derive global and specific benchmarks for various engagement scenarios. These components, singly or in combination, may generate measurements and metrics used to provide relevant, timely, meaningful and beneficial feedback to participants and organizations.

In an exemplary embodiment, the system 100 may provide managers a consolidated view of their cohort's and each participant's (member's, customer's, partner's, student's, fan's, referrer's, affiliate's, stakeholder's, contributor's, etc.) level of engagement and all the contributing inputs into the calculation.

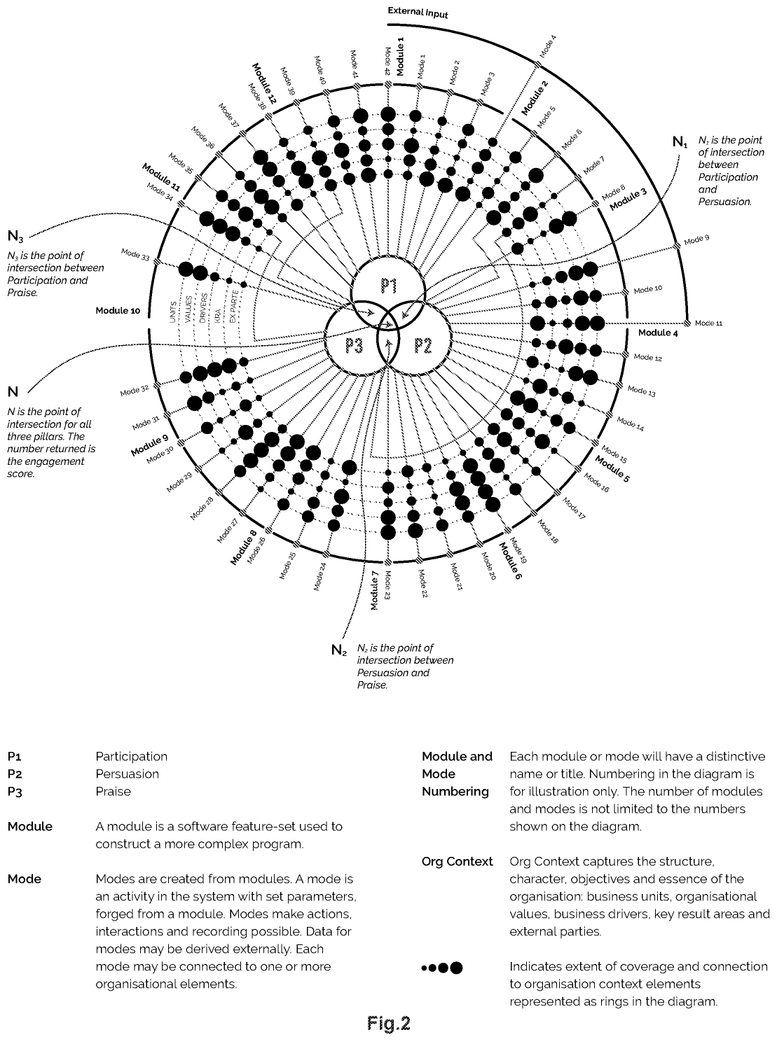

FIG. 2 shows a full view of the Engagement Pillars score calculation mechanism in accordance with an embodiment of the present disclosure. In FIG. 2, P1 represents participation, P2 represents Persuasion and P3 represents Praise. In FIG. 2 A module is a software feature-set used to construct a more complex program. Further, Modes are created from modules. A mode is an activity in the system with set parameters, forged from a module. Modes make actions, interactions and recording possible. Modes or activity data may be derived externally. Each mode may be connected to one or more organisational elements.

Each module or mode may have a distinctive name or title. Numbering in FIG. 2 is for illustration only. The number of modules and modes is not limited to the numbers shown on FIG. 2. Org Context may capture the structure, character, objectives and essence of the organisation: business units, organisational values, business drivers, key result areas and external parties.

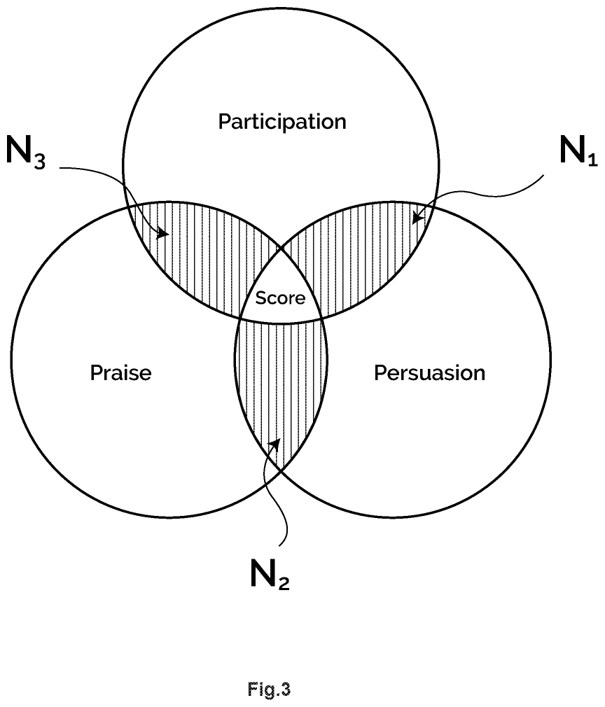

FIG. 3 of the present disclosure discloses an Engagement Framework in accordance with an embodiment of the present disclosure. FIG. 3 shows the three engagement pillars of the present invention and their intersection. The intersection point at the middle of the three pillars represents the engagement score of a participant.

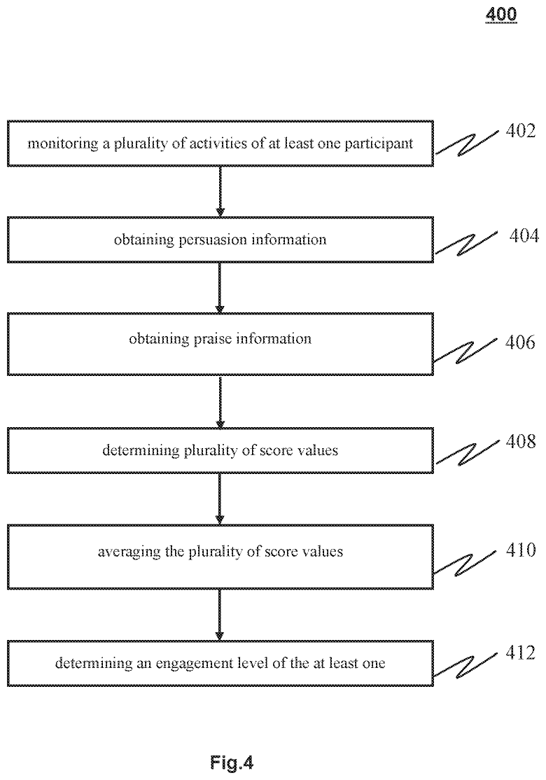

FIG. 4 shows a flowchart of an exemplary method 400 for generating participant engagement scores in accordance with an embodiment of the present disclosure. At block 402, the method describes monitoring a plurality of activities of at least one participant of an interaction platform. The participation information may be indicating involvement, attendance, presence, taking part, acting and reacting. At block 404, obtaining participation information associated with the at least one participant. At block 406, obtaining persuasion information associated with the at least one participant. At step 408, the method describes obtaining praise information associated with the at least one participant.

According to exemplary embodiment, persuasion may involve making a participant accountable for their actions, for their work, for meeting desired expectations. Persuasion also includes making the participant aware of their responsibilities, as well as tracking, calculating and measuring their performance. Persuasion may relate to key deliverables assigned to the participant. They cover the primary responsibilities of the participant's role, position or relationship that are measurable (like purchasing, selling, building, developing, solving, supporting, helping, fixing, growing, etc). Elementary inputs may include streams of data from Key Performance Indicators (KPI), Key Result Areas (KRA) and assigned Challenges.

At step 410 of the method, plurality of score values may be determined based on each of the participation information, persuasion information, and praise information, wherein the score values are determined based on the plurality of scores stored in a database. The method at step 412 describes evaluating the plurality of score values to determine a final score.

At the step 414, the method describes that an engagement level of the at least one participant may be determined based on the determined score. The engagement level of the at least one participant may be determined based on by comparing the determined final score with one or more thresholds.

According to exemplary embodiment, the participation information, the persuasion information, and praise information associated with the at least one participant may be determined based on at least one of the interaction platform and an external source.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed.

Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, nonvolatile memory, hard drives, CD ROMs, DVDs, flash drives, disks, and any other known physical storage media.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

What is claimed is:

1. A method for generating participant engagement scores, the method comprising:
monitoring a plurality of activities of at least one participant of an interaction platform;
obtaining participation information associated with the at least one participant;
obtaining persuasion information associated with the at least one participant;
obtaining praise information associated with the at least one participant;
determining plurality of score values based on each of the participation information, persuasion information, and praise information, wherein the score values are determined based on plurality of scores stored in a database;
evaluating the plurality of score values to determine a final score; and
determining an engagement level of the at least one participant based on the determined score.

2. The method as claimed in claim 1, wherein the participation information associated with the at least one participant is obtained utilizing at least one of the interaction platform and an external source.

3. The method as claimed in claim 1, wherein the persuasion information praise information associated with the at least one participant is obtained utilizing at least one of the interaction platform and an external source.

4. The method as claimed in claim 1, wherein the praise information associated with the at least one participant is obtained utilizing at least one of the interaction platform and an external source based on the plurality of activities.

5. The method as claimed in claim 1, wherein the participation information, the persuasion information, and the praise information associated with the at least one participant are obtained based on the plurality of activities.

6. The method as claimed in claim 1, wherein determining the engagement level of the at least one participant based on the determined score comprise:
comparing the determined score with one or more thresholds.

7. A system for generating participant engagement scores, the system comprises:
at least one processor;
an activity detecting unit; and
a database coupled to the at least one processor, wherein the at least one processor is configured to:
monitor a plurality of activities of at least one participant of an interaction platform,
obtain persuasion information associated with the at least one participant,
obtain praise information associated with the at least one participant,
determine plurality of score values based on each of the plurality of activities, participation information, persuasion information, and praise information, wherein the score values are determined based on plurality of scores stored in a database,
evaluating the plurality of score values to determine a final score, and
determine an engagement level of the at least one participant based on the determined score.

8. The system as claimed in claim 7, wherein the participation information associated with the at least one participant is obtained utilizing at least one of the interaction platform and an external source.

9. The system as claimed in claim 7, wherein the persuasion information associated with the at least one participant is obtained utilizing on at least one of the interaction platform and an external source.

10. The system as claimed in claim 7, wherein the praise information associated with the at least one participant is obtained utilizing at least one of the interaction platform and an external source.

11. The system as claimed in claim 7, wherein the participation information, the persuasion information, and the praise information associated with the at least one participant are obtained based on the plurality of activities.

12. The system as claimed in claim 7, wherein the at least one processor is configured to determine the engagement level of the at least one participant based on the determined score by:
comparing the determined score with one or more thresholds.

13. A non-transitory computer readable medium for storing computer instructions that, when executed by at least one processor cause the at least one processor to perform a method generating participant engagement scores comprising:
monitoring a plurality of activities of at least one participant of an interaction platform;
obtaining participation information associated with the at least one participant;
obtaining persuasion information associated with the at least one participant;
obtaining praise information associated with the at least one participant;
determining plurality of score values based on each of the participation information, persuasion information, and praise information, wherein the score values are determined based on plurality of scores stored in a database;
evaluating the plurality of score values to determine a final score; and
determining an engagement level of the at least one participant based on the determined score.

14. The computer readable medium as claimed in claim 13, wherein the participation information associated with the at least one participant is obtained utilizing at least one of the interaction platform and an external source.

15. The computer readable medium as claimed in claim 13, wherein the persuasion information associated with the at least one participant is obtained utilizing at least one of the interaction platform and an external source.

16. The computer readable medium as claimed in claim 9, wherein the praise information associated with the at least one participant is obtained utilizing at least one of the interaction platform and an external source.

17. The computer readable medium as claimed in claim 13, wherein the participation information, the persuasion information, and the praise information associated with the at least one participant are obtained based on the plurality of activities.

18. The computer readable medium as claimed in claim 13, wherein determining the engagement level of the at least one participant based on the determined final score comprise:
comparing the determined score with one or more thresholds.
